(19) United States
(12) Patent Application Publication
(10) Pub. No.: US 2018/0096350 A1
(43) Pub. Date: Apr. 5, 2018

(54) METHOD AND SYSTEM FOR CORRELATING MOBILE DEVICE LOCATION WITH ELECTRONIC TRANSACTION DATA

(71) Applicant: MasterCard International Incorporated, Purchase, NY (US)

(72) Inventors: Peter J. GROARKE, Dublin 18 (IE); Jean TURNBULL, Mississauga (CA); Matt WICKMAN, O'Fallon, MO (US); Mark B. WIESMAN, Chesterfield, MO (US); Winifred Elizabeth HOUSE, Troy, MO (US)

(73) Assignee: MasterCard International Incorporated, Purchase, NY (US)

(21) Appl. No.: 15/285,085

(22) Filed: Oct. 4, 2016

(51) Int. Cl. G06Q 20/40; H04L 9/32; G06F 17/30; H04L 29/08

(52) U.S. Cl. CPC G06Q 20/40; H04L 9/3242; G06F 17/30477; H04L 67/18; G06F 17/30241

(57) ABSTRACT

A method for privacy protection in use of geolocation for transaction authorization includes: storing location profiles including a device identifier and account identifier; receiving a location notification including a specific device identifier and a geolocation; identifying a specific location profile including the specific device identifier; transmitting the geolocation and the account identifier in the specific location profile to a second computing device; receiving, at the second computing device, a transaction message related to a payment transaction including an account number corresponding to the account identifier, a transaction location, and authorization data; determining if the geolocation corresponds to the transaction location; storing a result of the determination in the authorization data; and transmitting the transaction message to a financial institution associated with a transaction account corresponding to the account number.

### FIELD

The present disclosure relates to the protection of privacy in the use of mobile device locations in electronic transactions, specifically the use of multiple, separated computing devices in a processing system that correlates mobile device locations with a transaction account for use in transaction processing to protect consumer and processor privacy.

### BACKGROUND

Consumers and financial institutions are often interested in trying to prevent fraud when it comes to electronic payment transactions. Fraudulent transactions can adversely affect a consumer's transaction account, preventing them from being able to use it and sometimes irreversibly harming their credit, and may also be detrimental to the related financial institution, who may suffer from economic loss as a result of the fraud.

As the consumer usage of mobile computing devices becomes more and more prevalent, one method that has been developed to help combat fraud has been the use of the geolocation of a consumer's mobile device. In such methods, a consumer registers their mobile device, via a phone number or other identifying information, with their financial institution or a payment network. The entity will receive updates regarding the registered device's geolocation at regular intervals, when a change in location is detected (e.g., the device has left the state or country), or when queried (e.g., at the time of a new transaction), either directly from the mobile device itself or via a third party, such as a mobile network operator. The financial institution or payment network compares the device geolocation with a geolocation for the payment transaction, and make a fraud determination accordingly.

However, while such methods can be beneficial in protecting the security of a consumer's transaction account, it relies on a consumer being willing to share their device information, geolocation, and transaction history all with a single entity. Many consumers may find this to be an invasion of their personal privacy that may outweigh the benefits of increased account security. Thus, there is a need for a technical solution where a device geolocation can be used in fraud determinations for a payment transaction, while also keeping device identification and geolocation information quarantined from transaction data, so that a high level of both consumer privacy and account security may be maintained.

### SUMMARY

The present disclosure provides a description of systems and methods for the protection of privacy in the use of mobile device geolocation in the authorization of an electronic payment transaction. The systems and methods discussed herein use multiple computing devices in a processing system where device identification and geolocation information are kept separate from transaction data by use of the multiple, distinct computing devices, which enables the use of the mobile device geolocation without sacrificing consumer privacy.

A method for privacy protection in use of geolocation for transaction authorization includes: storing, in a location database of a first computing device, a plurality of location profiles, wherein each location profile includes a structured data set related to a mobile computing device including at least a device identifier and an account identifier; receiving, by a receiving device of the first computing device, a location notification from a third party system, the location notification including at least a specific device identifier and an identified geolocation; executing, by a querying module of the first computing device, a query on the location database to identify a specific location profile where the included device identifier corresponds to the specific device identifier; electronically transmitting, by a transmitting device of the first computing device, at least the identified geolocation and the account identifier included in the identified specific location profile to a second computing device; receiving, by a receiving device of the second computing device, a transaction message related to a payment transaction via a payment network, wherein the transaction message is formatted pursuant to one or more standards and includes at least a plurality of data elements including at least a first data element configured to store a primary account number corresponding to the account identifier transmitted to the second computing device, a second data element configured to store a transaction location, a third data element configured to store authorization data, and one or more additional data elements configured to store additional transaction data; determining, by a transaction processing module of the second computing device, if the identified geolocation transmitted to the second computing device corresponds to the transaction location stored in the second data element included in the received transaction message; storing, by the transaction processing module of the second computing device, a result of the determination in the third data element included in the received transaction message; and electronically transmitting, by a transmitting device of the second computing device, the transaction message including the third data element storing the result of the determination to a financial institution associated with a transaction account corresponding to the primary account number stored in the first data element included in the transaction message via the payment network.

A system for privacy protection in use of geolocation for transaction authorization includes: a location database of a first computing device configured to store a plurality of location profiles, wherein each location profile includes a structured data set related to a mobile computing device including at least a device identifier and an account identifier; a receiving device of the first computing device configured to receive a location notification from a third party system, the location notification including at least a specific device identifier and an identified geolocation; a querying module of the first computing device configured to execute a query on the location database to identify a specific location profile where the included device identifier corresponds to the specific device identifier; a transmitting device of the first computing device configured to electronically transmit at least the identified geolocation and the account identifier included in the identified specific location profile to a second computing device; a receiving device of the second computing device configured to receive a transaction message related to a payment transaction via a payment network, wherein the transaction message is formatted pursuant to one or more standards and includes at least a plurality of data elements including at least a first data element configured to store a primary account number corresponding to the account identifier transmitted to the second computing device, a second data element configured to store a transaction location, a third data element configured to store authorization data, and one or more additional data elements configured to store additional transaction data; a transaction processing module of the second computing device configured to determine if the identified geolocation transmitted to the second computing device corresponds to the transaction location stored in the second data element included in the received transaction message, and store a result of the determination in the third data element included in the received transaction message; and a transmitting device of the second computing device configured to electronically transmit the transaction message including the third data element storing the result of the determination to a financial institution associated with a transaction account corresponding to the primary account number stored in the first data element included in the transaction message via the payment network.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the protection of consumer privacy in the use of a device geolocation in transaction authorization in accordance with exemplary embodiments.

FIG. 2 is a block diagram illustrating the first computing device of the processing system of FIG. 1 for the identification and supply of a device geolocation in accordance with exemplary embodiments.

FIG. 3 is a block diagram illustrating the second computing device of the processing system of FIG. 1 for the usage of a device geolocation in transaction authorization in accordance with exemplary embodiments.

FIGS. 4A and 4B are a flow diagram illustrating a process for protecting consumer privacy while using a device geolocation in a transaction authorization using the system of FIG. 1 in accordance with exemplary embodiments.

FIG. 5 is a flow chart illustrating an exemplary method for privacy protection in use of geolocation for transaction authorization in accordance with exemplary embodiments.

FIG. 6 is a flow diagram illustrating the processing of a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

### System for Protection of Consumer Privacy in Geolocation Usage

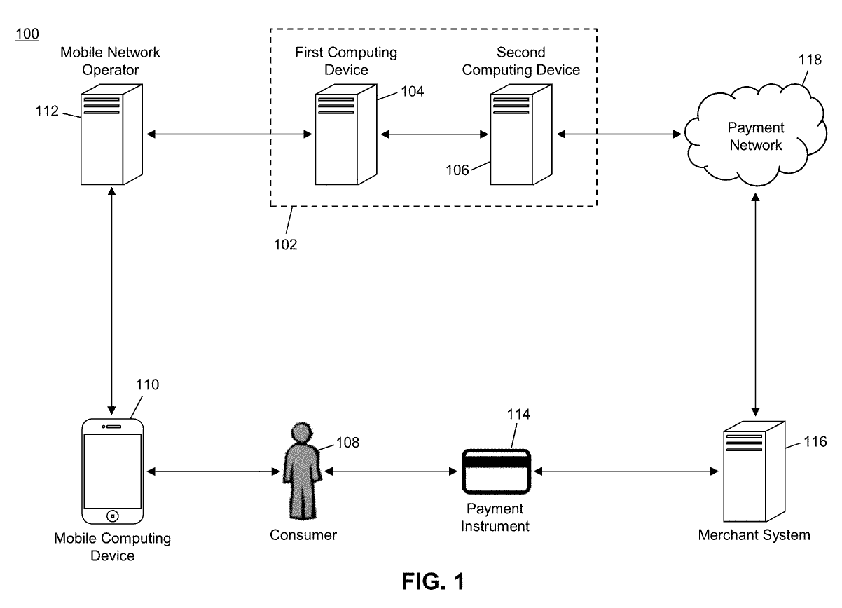

FIG. 1 illustrates a system 100 for the protection of consumer privacy in the usage of a mobile device geolocation in the authorization of an electronic payment transaction.

The system 100 may include a processing system 102. The processing system 102 may be configured to perform determinations based on consumer mobile device geolocation and transaction geolocation for electronic payment transactions, for use in authorization of the electronic payment transactions. To protect consumer privacy, the processing system 102 may include multiple computing devices, at least a first computing device 104 and a second computing device 106. The first computing device 104, discussed in more detail below, may be configured to gather geographic locations of mobile computing devices for use in determinations by the processing systems 102. The second computing device 106, discussed in more detail below, may be configured to perform the determination for an electronic payment transaction based on a geographic location provided by the first computing device 106. In an exemplary embodiment, the first computing device 104 may not receive or possess transaction data for the payment transaction, and the second computing device 106 may not receive or possess mobile computing device identification information or additional geolocation data. In such embodiments, the separation of the computing devices and their duties in the processing system 102 may enable the processing system 102 to perform determinations for use in authorization while maintaining a high level of consumer privacy.

In the system 100, a consumer 108 may register a mobile computing device 110 for use with the service provided by processing system 102. The mobile computing device 110 may be any type of computing device suitable for performing the functions discussed herein, such as a cellular phone, smart phone, smart watch, wearable computing device, implantable computing device, tablet computer, laptop computer, etc. In some embodiments, the consumer 108 may register the mobile computing device 110 directly with the processing system 102. In other embodiments, the consumer 108 may register the mobile computing device 110 via an intermediate entity, such as a mobile network operator 112. The mobile network operator 112 may be an entity associated with the mobile computing device 110 or a communication network configured to communicate with the mobile computing device 110, which may be configured to receive data signals electronically transmitted by the mobile computing device 110, including data signals superimposed or otherwise encoded with geographic location data.

As part of the registration process, a device identifier associated with the mobile computing device 110 may be supplied to the processing system 102. The device identifier may be transmitted directly to the processing system 102 by the mobile computing device 110, or transmitted to the mobile network operator 112, which may forward the device identifier to the processing system 102. The device identifier may be a unique value associated with the mobile computing device 110 that is unique to that individual mobile computing device 110, such as a telephone number, media access control (MAC) address, identification number, registration number, serial number, username, email address, telephone number, etc. The device identifier may be stored in a location profile in the first computing device 104, discussed in more detail below, for use in performing the functions of the processing system 102 discussed herein.

In some embodiments, the device identifier provided to the processing system 102 may not be directly associated with the mobile computing device 110. For instance, in such an embodiment, the mobile computing device 110 may register its associated unique value (e.g., a MAC address) with the mobile network operator 112. The mobile network operator 112 may then generate or otherwise identify a new device identifier to be registered with the processing system 102, that is used for communications between the processing system 102 and mobile network operator 112, for communications involving the mobile computing device 110. In such instances, the device identifier provided to the processing system 102 may not be identified as being associated with the mobile computing device 110 except by the mobile network operator 112. The new device identifier may be any suitable type of identifying value, such as a hash value generated via hashing the unique value provided by the mobile computing device 110 with a one-way hashing algorithm.

During the registration process, the consumer 108 may also register a transaction account with the processing system 102. The registered transaction account may be a transaction account used by the consumer 108 in an electronic payment transaction where the processing system 102 is to make a determination for authorization based on the geographic location of the mobile computing device 110. The transaction account may be issued to the consumer 108 by a suitable financial institution, such as an issuing bank. As part of the issuance of the transaction account to the consumer 108, the issuing financial institution may issue a payment instrument 114 to the consumer 108. The payment instrument 114 may be encoded or may otherwise store payment details corresponding to the transaction account, for conveyance during initiation of a payment transaction to be funded by the transaction account. The payment details may include at least an account number for the transaction account, in addition to any other payment data that may be used in the processing of a payment transaction, such as a transaction counter, payment cryptograms, etc.

Registration of the transaction account may include the communication of the account number for the transaction account to the processing system 102. In some embodiments, the consumer 108 may register the transaction account directly with the processing system 102, such as using the mobile computing device 110. In other embodiments, the consumer 108 may register the transaction account via another entity, such as the mobile network operator 112 or the issuing financial institution. Registration of the transaction account may include the communication of the account number, and of the device identifier that is directly or indirectly associated with the mobile computing device 110. The first computing device 104 of the processing system 102 may receive the account number, which may be stored in the location profile that also includes the device identifier. The first computing device 104 may thus have a location profile for the consumer 108 that includes their device identifier and account number.

In some embodiments, the first computing device 104 may use an alternative account identifier in place of the transaction account's actual account number. In such embodiments, the first computing device 104 of the processing system 102 may hash the account number upon receipt from the mobile computing device 110 or third party entity. The hashing of the account number may include the application of one or more hashing algorithms to the account number to generate a hash value to serve as the account identifier. The account identifier may then be stored in the location profile instead of the account number, which may as a result not be received or possessed by the first computing device 104.

After registration of the mobile computing device 110 and transaction account, the consumer 108 may initiate a payment transaction with a merchant. As part of the initiation, the consumer 108 may present the payment instrument 114 to a merchant system 116. The merchant system 116 may be any type of computing system associated with a merchant suitable for use in the receipt and conveyance of payment details and additional transaction data for a payment transaction, such as a point of sale system. The merchant system 116 may receive the payment details from the payment instrument 114, which may be read or otherwise received from the payment instrument 114 using any suitable method. For example, the merchant system 116 may read the payment details from a magnetic stripe in the payment instrument 114, may read the payment details from a machine-readable code displayed by the payment instrument 114, may receive the payment details from an electronic transmission from the payment instrument 114 using near field communication, etc.

The merchant system 116 may submit the payment details and other transaction data to a payment network 118 for processing of the payment transaction. The other transaction data may include at least a geographic location any additional data related to the payment transaction used in the processing thereof, such as a transaction amount, transaction time, transaction date, merchant name, merchant category code, merchant data, point of sale data, issuer data, acquirer data, product data, offer data, loyalty data, reward data, etc. In some instances, the merchant system 116 may directly submit the transaction data (e.g., the payment details and other transaction data) to the payment network 118 via payment rails associated with the payment network 118. In other instances, the merchant system 116 may electronically transmit the transaction data to one or more third party entities for forwarding to the payment network 118, such as an acquiring financial institution or gateway processor.

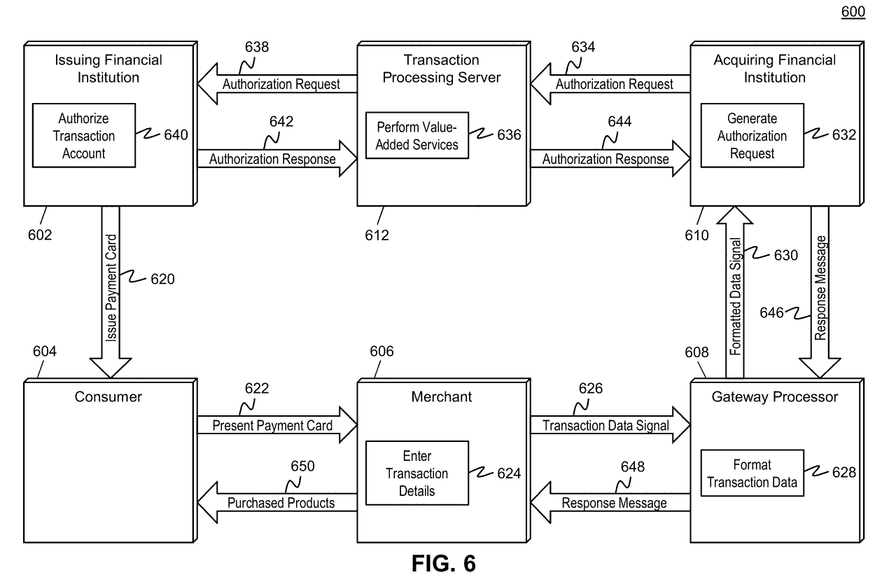

In some embodiments, the transaction data may be formatted (e.g., by the merchant system 116 or a third party entity to which the transaction data is provided) in a specially formatted transaction message for transmission to the payment network 118. The transaction message may be a specially formatted data message that is formatted pursuant to one or more standards governing the exchange of financial transaction messages, such as the International Organization for Standardization's ISO 8583 or 20022 standards. A transaction message may include a message type indicator indicative of a type of the payment transaction, such as an authorization request or authorization response. A transaction message may also include a plurality of data elements, where each data element is configured to store transaction data for the payment transaction, such as a first data element configured to store a primary account number, a second data element configured to store a geographic location, etc. In some embodiments, a transaction message may also include one or more bitmaps, which may be configured to indicate the data elements included in the transaction message and the data stored therein. Additional information regarding the conveyance and usage of transaction messages for the traditional processing of a payment transaction is discussed in more detail below with respect to the process 600 illustrated in FIG. 6.

The payment network 118 may receive a transaction message for the payment transaction (e.g., directly from the merchant system 116 or via a third party entity) via the payment rails associated therewith that includes a message type indicator indicative of an authorization request and a plurality of data elements including at least a first data element configured to store the account number associated with the registered transaction account (e.g., as read from the payment instrument 114), a second data element configured to store a geographic location for the payment transaction, a third data element configured to store authorization data, and one or more additional data elements configured to store additional transaction data. The payment network 118 may perform any actions related to the processing of the payment transaction prior to authorization (e.g., mapping of account numbers, application of transaction controls, etc.) and may forward the authorization request to the processing system 102. In some embodiments, the authorization request may be electronically transmitted to the processing system 102 via the payment rails associated with the payment network 118. In other embodiments, the processing system 102 may be a part of the payment network 118 and may receive the authorization request via internal communication networks and methods.

The authorization request may be received by the second computing device 106 of the processing system 102. The second computing device 106 may parse the transaction data from the transaction message, to retrieve at least the account number and the geographic location stored therein. The second computing device 106 may then compare the geographic location of the payment transaction with a geographic location of the mobile computing device 110 to determine if there is a correspondence, for use in the authorization of the payment transaction. The second computing device 106 may electronically transmit a data signal to the first computing device 104 via internal communication networks and methods of the processing system 102 that is superimposed or otherwise encoded with a location request. The location request may include the account number parsed from the authorization request. In embodiments where an account identifier may be used, the second computing device 106 may first generate the account identifier that corresponds to the account number via the same hashing algorithm(s) used by the first computing device 104 during registration, and then use the account identifier in the location request as an alternative to the account number.

The first computing device 104 may receive the location request and may identify a geographic location corresponding to the received account number or account identifier. The first computing device 104 may identify the location profile where the account number or identifier was registered, and the device identifier that is included therein. The first computing device 104 may then request the geographic location of the mobile computing device 110 associated (e.g., directly or indirectly) with the device identifier. The first computing device 104 may electronically transmit a data signal to the mobile network operator 112 that is superimposed or otherwise encoded with the device identifier. The mobile network operator 112 may then identify the geographic location of the mobile computing device 110 associated therewith (e.g., or with the corresponding unique value as identified by the mobile network operator 112) using traditional methods and systems for identifying a mobile computing device 110 geolocation. The mobile network operator 112 may electronically transmit a data signal back to the first computing device 104 that is superimposed or otherwise encoded with the device identifier and the identified geographic location. The first computing device 104 may then electronically transmit the geographic location and the account number or identifier to the second computing device 106 via internal communication methods.

In such embodiments, the first computing device 104 may request a geographic location of the mobile computing device 110 identified at the time of the request. In some alternative embodiments, the mobile network operator 112 may regularly (e.g., periodically at predetermined intervals, such as hourly, bi-hourly, daily, etc., when a new geographic location is detected, etc.) identify the geographic location of the mobile computing device 110. In such embodiments, the mobile network operator 112 may respond to the first computing device 104 with the most recently identified geographic location of the mobile computing device 110. In other embodiments, the mobile network operator 112 may report the geographic location of the mobile computing device 110 regularly, such as when it is identified by the mobile network operator 112 or when a change in geographic location of the mobile computing device 110 is detected. In such embodiments, the first computing device 104 may store the most recent geographic location in the location profile for the mobile computing device 110, which may be provided to the second computing device 106 when requested for a payment transaction.

After the second computing device 106 has received the geographic location for the mobile computing device 110, the second computing device 106 may determine if it corresponds to the geographic location of the payment transaction parsed from the authorization request. In some instances, a correspondence may be identified if the geographic locations match (e.g., the same physical address, zip code or postal code, municipal demarcation, state, etc.). In other instances, a correspondence may be identified based on the inclusion of each geographic location in the same geographic area. For example, the geographic location identified for the mobile computing device 110 may be a state, where a correspondence may be identified if the geographic location for the payment transaction is a city in that same state.

The second computing device 106 may store a result of the determination in the authorization request. The result may be stored in the third data element configured to store authorization data. The second computing device 106 may then electronically transmit the authorization request with the result included back to the payment network 118. The payment network 118 may forward the authorization request on to the issuing financial institution for determining authorization based thereon. For example, if the second computing device 106 determines that the two geographic locations do not correspond, the authorization data may indicate the failed determination, which may be used by the issuing financial institution in deciding to decline the payment transaction due to suspicion of fraud. The issuing financial institution may generate and submit an authorization response to the payment network 118 based on their decision using traditional methods and systems. The payment network 118 may then forward the authorization response on to the merchant system 116 (e.g., via an intermediate entity, as applicable) using the payment rails. The merchant system 116 may then finalize the payment transaction accordingly, such as by furnishing the consumer 108 with transacted-for goods or services if the transaction was approved.

In some embodiments, the second computing device 106 may be configured to decline a payment transaction if the result of the determination is negative. In such an embodiment, if the second computing device 106 determines that there is no correspondence between the geographic location of the mobile computing device 110 and the geographic location of the payment transaction, the second computing device 106 may generate an authorization response indicating that the payment transaction is declined. The authorization response may be a newly generated transaction message, or a modification of the received authorization request, that includes a message type indicator indicative of an authorization response. The authorization response may also include the data elements included in the authorization request, with a data element configured to store a response code included therein. The data element configured to store a response code may be the same or a different data element as the data element configured to store authorization data. The response code may indicate if the payment transaction is approved or denied, and, in some instances, may indicate a reason for the denial. The authorization response generated by the second computing device 104 may include a reason code indicating that the payment transaction is declined due to suspicion of fraud. The second computing device 106 may electronically transmit the authorization response to the payment network 118, which may continue processing of the payment transaction accordingly.

The methods and systems discussed herein may enable the processing system 102 to provide determinations of correspondences between mobile computing device 110 geographic locations and payment transaction geographic locations for use in authorization of the payment transaction that provides a high level of protection of both consumer privacy and account security. By using the first computing device 104 and second computing device 106, the processing system 102 may make the determination without any computing device being in possession of both mobile device data and transaction data at any time. In cases where the first computing device 104 does not retain geographic locations, the determinations may be made while also protecting location data for consumers 108. In instances where alternative device identifiers and/or account identifiers are used, an even greater level of consumer privacy may be maintained, while still providing consumers 108 with the additional account security of using mobile device geolocation in authorization decisions.

### First Computing Device

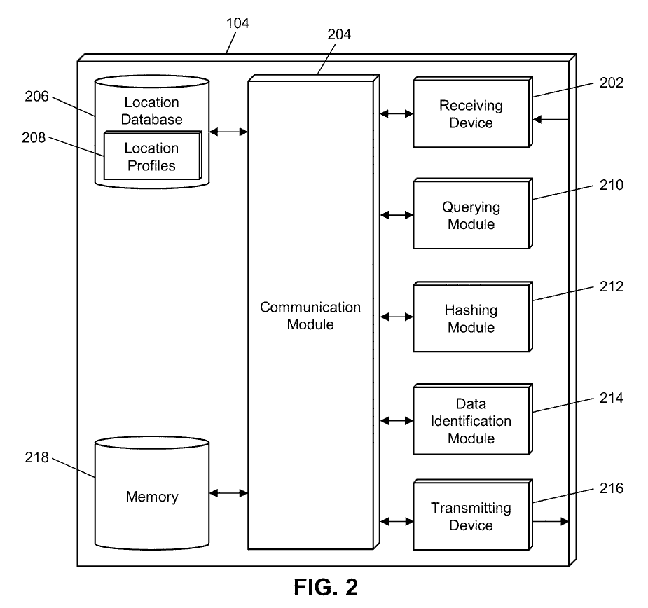

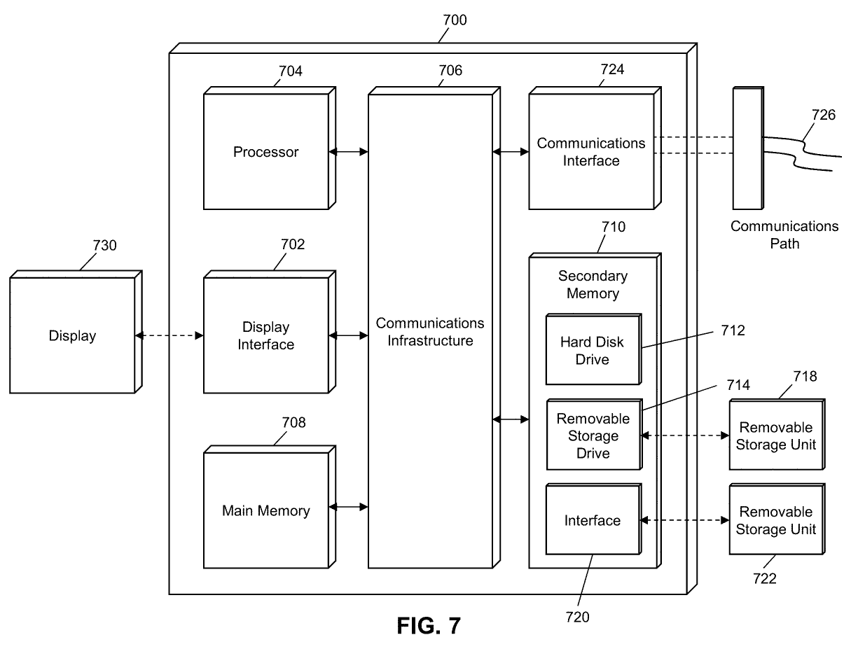

FIG. 2 illustrates an embodiment of the first computing device 104 of the system 100. It will be apparent to persons having skill in the relevant art that the embodiment of the first computing device 104 illustrated in FIG. 2 is provided as illustration only and may not be exhaustive to all possible configurations of the first computing device 104 suitable for performing the functions as discussed herein. For example, the computer system 700 illustrated in FIG. 7 and discussed in more detail below may be a suitable configuration of the first computing device 104.

The first computing device 104 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 118 for the transmission of transaction messages that include sensitive financial data and information. In some instances, the receiving device 202 may also be configured to receive data from the second computing device 106, mobile network operators 112, mobile computing devices 110, financial institutions, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by mobile network operators 112 and/or mobile computing devices 110 that are superimposed or otherwise encoded with registration data. Registration data may include at least a device identifier directly or indirectly associated with a mobile computing device 110 and an account number or other identifying information associated with a transaction account. The receiving device 202 may also be configured to receive data signals electronically transmitted by mobile network operators 112 and/or mobile computing devices 110 that are superimposed or otherwise encoded with location notifications, which may include at least a device identifier and a geographic location identified for the corresponding mobile computing device 110. In some embodiments, the receiving device 202 may be configured to hash data upon receipt. For example, the receiving device 202 may automatically hash an account number or device unique value upon receipt via the application of one or more hashing algorithms thereto, to prevent access and storage of the original, underlying value.

The first computing device 104 may also include a communication module 204. The communication module 204 may be configured to transmit data between modules, engines, databases, memories, and other components of the first computing device 104 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the first computing device 104 and external components of the first computing device 104, such as externally connected databases, display devices, input devices, etc. The first computing device 104 may also include a processing device. The processing device may be configured to perform the functions of the first computing device 104 discussed herein as will be apparent to persons having skill in the relevant art. In some embodiments, the processing device may include and/or be comprised of a plurality of engines and/or modules specially configured to perform one or more functions of the processing device, such as a querying module 210, hashing module 212, data identification module 214, etc. As used herein, the term “module” may be software or hardware particularly programmed to receive an input, perform one or more processes using the input, and provide an output. The input, output, and processes performed by various modules will be apparent to one skilled in the art based upon the present disclosure.

The first computing device 104 may include a location database 206. The location database 206 may be configured to store a plurality of location profiles 208 using a suitable data storage format and schema. The location database 206 may be a relational database that utilizes structured query language for the storage, identification, modifying, updating, accessing, etc. of structured data sets stored therein. Each location profile 208 may be a structured data set configured to store data related to a mobile computing device 110. Each location profile 208 may include at least a device identifier and an account identifier. The device identifier may be a unique value directly associated with a mobile computing device 110, or a identification value associated with such a unique value that may, as a result, be indirectly related to the mobile computing device 110. Indirect values may be identified by the mobile network operator 112 and provided to the first computing device 104, or may be generated by the first computing device 104 via the hashing of the underlying unique value. The account identifier may be an account number or other identifier, such as a hash value generated via hashing of the account number, associated with a transaction account. In some embodiments, the location profile 208 may also include at least one geographic location identified for the related mobile computing device 110. In an exemplary embodiment, the location profile 208 may include only the most recent geographic location identified for the related mobile computing device 110, and may discard the geographic location upon receipt of a newer one, as to not retain historic location data for any mobile computing device 110.

The first computing device 104 may include a querying module 210. The querying module 210 may be configured to execute queries on databases to identify information. The querying module 210 may receive one or more data values or query strings, and may execute a query string based thereon on an indicated database, such as the location database 206, to identify information stored therein. The querying module 210 may then output the identified information to an appropriate engine or module of the first computing device 104 as necessary. The querying module 210 may, for example, execute a query on the location database 206 to identify a location profile 208 for which a geographic location is received from the mobile network operator 112, using an accompanying device identifier. The querying module 210 may also execute a query on the location database 206 to identify a location profile 208 for which a request is received from the second computing device 106, such as using an account identifier included therein, for identification of a corresponding geographic location.

The first computing device 104 may also include a hashing module 212. The hashing module 212 may be configured to generate hash values via the use of hashing algorithms. The hashing module 212 may receive a data value to be hashed as input, may hash the data value to generate a hash value via the application of one or more hashing algorithms thereto, and may output the hash value to another module or engine of the first computing device 104. In some instances, the input may also include an indication of the hashing algorithm or algorithms to use. In other instances, the hashing module 212 may be configured to identify the hashing algorithm or algorithms. In an example, the hashing module 212 may be configured to hash unique values and account numbers received by the receiving device 202 upon receipt to generate device identifiers and account identifiers, respectively. In some such instances, the hashing module 212 may use hashing algorithms known to the mobile network operator 112 and/or second computing device 106 accordingly, such that each entity or device may generate the same hash value from the same original value.

The first computing device 104 may also include a data identification module 214. The data identification module 214 may be configured to identify data for use in performing the functions of the first computing device 104 as discussed herein. The data identification module 214 may receive an instruction regarding data to be identified, may identify the data, and may output the data to another module or engine of the first computing device 104. For example, the data identification module 214 may receive an instruction (e.g., via the receiving device 202, such as electronically transmitted from the second computing device 106) requesting identification of a geographic location of a mobile computing device 110. The data identification module 214 may generate a query for execution by the querying module 210 to identify a corresponding location profile 208 for the identification of a geographic location stored therein, or for the device identifier stored therein for inclusion in a data request generated by the data identification module 214 for transmission to a mobile network operator 112 for identification of the geographic location of the mobile computing device 110.

The first computing device 104 may also include a transmitting device 216. The transmitting device 216 may be configured to transmit data over one or more networks via one or more network protocols. In some embodiments, the transmitting device 216 may be configured to transmit data over the payment rails, such as using specially configured infrastructure associated with payment networks 118 for the transmission of transaction messages that include sensitive financial data and information, such as identified payment credentials. In some instances, the transmitting device 216 may be configured to transmit data to second computing devices 106, mobile network operators 112, mobile computing devices 110, financial institutions, and other entities via alternative networks, such as the Internet. In some embodiments, the transmitting device 216 may be comprised of multiple devices, such as different transmitting devices for transmitting data over different networks, such as a first transmitting device for transmitting data over the payment rails and a second transmitting device for transmitting data over the Internet. The transmitting device 216 may electronically transmit data signals that have data superimposed that may be parsed by a receiving computing device. In some instances, the transmitting device 216 may include one or more modules for superimposing, encoding, or otherwise formatting data into data signals suitable for transmission.

The transmitting device 216 may be configured to electronically transmit data signals to mobile network operators 112 and/or mobile computing devices 110 requesting geographic location data that are superimposed or otherwise encoded with at least a device identifier and an indication that the geographic location of a corresponding mobile computing device 110 is requested. The transmitting device 216 may also be configured to electronically transmit data signals to the second computing device 106, which may be superimposed or otherwise encoded with at least an account identifier and a corresponding geographic location, for use in authorization determinations of payment transactions.

The first computing device 104 may also include a memory 218. The memory 218 may be configured to store data for use by the first computing device 104 in performing the functions discussed herein. The memory 218 may be configured to store data using suitable data formatting methods and schema and may be any suitable type of memory, such as read-only memory, random access memory, etc. The memory 218 may include, for example, encryption keys and algorithms, communication protocols and standards, data formatting standards and protocols, program code for modules and application programs of the processing device, and other data that may be suitable for use by the first computing device 104 in the performance of the functions disclosed herein as will be apparent to persons having skill in the relevant art. In some embodiments, the memory 218 may be comprised of or may otherwise include a relational database that utilizes structured query language for the storage, identification, modifying, updating, accessing, etc. of structured data sets stored therein.

### Second Computing Device

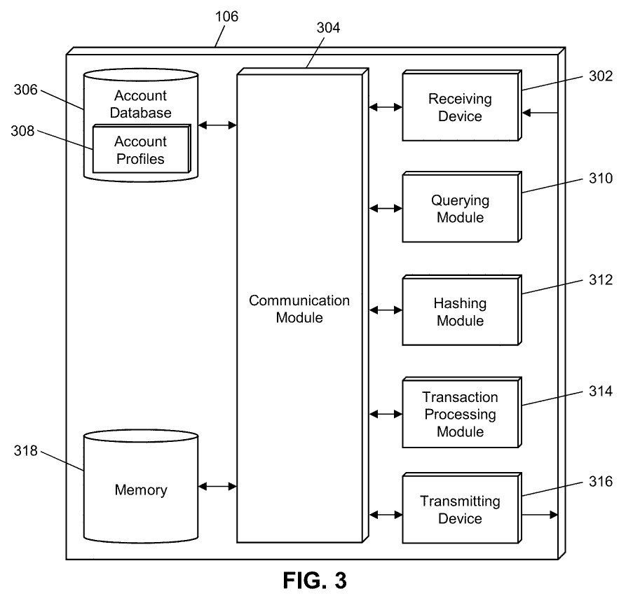

FIG. 3 illustrates an embodiment of the second computing device 106 of the system 100. It will be apparent to persons having skill in the relevant art that the embodiment of the second computing device 106 illustrated in FIG. 3 is provided as illustration only and may not be exhaustive to all possible configurations of the second computing device 106 suitable for performing the functions as discussed herein. For example, the computer system 700 illustrated in FIG. 7 and discussed in more detail below may be a suitable configuration of the second computing device 106.

The second computing device 106 may include a receiving device 302. The receiving device 302 may be configured to receive data over one or more networks via one or more network protocols. In some embodiments, the receiving device 302 may be configured to receive data over the payment rails, such as using specially configured infrastructure associated with payment networks 118 for the transmission of transaction messages that include sensitive financial data and information. In some instances, the receiving device 302 may also be configured to receive data from the first computing device 104, payment networks 118, merchant systems 116, financial institutions, and other entities via alternative networks, such as the Internet. In some embodiments, the receiving device 302 may be comprised of multiple devices, such as different receiving devices for receiving data over different networks, such as a first receiving device for receiving data over payment rails and a second receiving device for receiving data over the Internet. The receiving device 302 may receive electronically transmitted data signals, where data may be superimposed or otherwise encoded on the data signal and decoded, parsed, read, or otherwise obtained via receipt of the data signal by the receiving device 302. In some instances, the receiving device 302 may include a parsing module for parsing the received data signal to obtain the data superimposed thereon. For example, the receiving device 302 may include a parser program configured to receive and transform the received data signal into usable input for the functions performed by the processing device to carry out the methods and systems described herein.

The receiving device 302 may be configured to receive data signals electronically transmitted by payment networks 118, merchant systems 116, or third party entities that may be superimposed or otherwise encoded with transaction messages for payment transactions. The transaction messages may be transmitted via payment rails associated with a payment network 118 and may be formatted pursuant to one or more standards, such as the ISO 8583 and 20022 standards. Transaction messages may include a plurality of data elements including at least a data element configured to store a primary account number, a data element configured to store a geographic location, and a data element configured to store authorization data. The receiving device 302 may also be configured to receive data signals electronically transmitted by the first computing device 104, which may be superimposed or otherwise encoded with at least an account identifier and a corresponding geographic location.

The second computing device 106 may also include a communication module 304. The communication module 304 may be configured to transmit data between modules, engines, databases, memories, and other components of the second computing device 106 for use in performing the functions discussed herein. The communication module 304 may be comprised of one or more communication types and utilize various communication methods for communications within a computing device. For example, the communication module 304 may be comprised of a bus, contact pin connectors, wires, etc. In some embodiments, the communication module 304 may also be configured to communicate between internal components of the second computing device 106 and external components of the second computing device 106, such as externally connected databases, display devices, input devices, etc. The second computing device 106 may also include a processing device. The processing device may be configured to perform the functions of the second computing device 106 discussed herein as will be apparent to persons having skill in the relevant art. In some embodiments, the processing device may include and/or be comprised of a plurality of engines and/or modules specially configured to perform one or more functions of the processing device, such as a querying module 310, hashing module 312, transaction processing module 314, etc. As used herein, the term “module” may be software or hardware particularly programmed to receive an input, perform one or more processes using the input, and provide an output. The input, output, and processes performed by various modules will be apparent to one skilled in the art based upon the present disclosure.

In some embodiments, the second computing device 106 may include an account database 306. The account database 306 may be configured to store a plurality of account profiles 308 using a suitable data storage format and schema. The account database 306 may be a relational database that utilizes structured query language for the storage, identification, modifying, updating, accessing, etc. of structured data sets stored therein. Each account profile 308 may be a structured data set configured to store data related to a transaction account. Each account profile 308 may include at least an account number associated with the related transaction account and an account identifier corresponding thereto. In some instances, the account identifier may be generated by the second computing device 106, such as via the hashing module 312 as discussed below. In such embodiments, the second computing device 106 may use the account identifier in place of the account number for communications with the first computing device 104.

The second computing device 106 may include a querying module 310. The querying module 310 may be configured to execute queries on databases to identify information. The querying module 310 may receive one or more data values or query strings, and may execute a query string based thereon on an indicated database, such as the account database 306, to identify information stored therein. The querying module 310 may then output the identified information to an appropriate engine or module of the second computing device 106 as necessary. The querying module 310 may, for example, execute a query on the account database 206 to identify an account profile 308 related to a transaction message received for a payment transaction, for identification of the account identifier stored therein for use in identifying a geographic location for use in determining authorization of the payment transaction.

The second computing device 106 may also include a hashing module 312. The hashing module 312 may be configured to generate hash values via the use of hashing algorithms. The hashing module 312 may receive a data value to be hashed as input, may hash the data value to generate a hash value via the application of one or more hashing algorithms thereto, and may output the hash value to another module or engine of the second computing device 106. In some instances, the input may also include an indication of the hashing algorithm or algorithms to use. In other instances, the hashing module 312 may be configured to identify the hashing algorithm or algorithms. In an example, the hashing module 312 may be configured to hash account numbers received by the receiving device 302 (e.g., as stored in a corresponding data element included in a received authorization request) to generate a corresponding account identifier.

The second computing device 106 may also include a transaction processing module 314. The transaction processing module 314 may be configured to perform functions related to the processing of payment transactions, including traditional functions related to the analysis and processing of authorization requests and authorization responses and the generation of transaction messages related thereto. The transaction processing module 314 may also be configured to make determinations based on geographic locations for a payment transaction. The transaction processing module 314 may receive a transaction message and a geographic location associated with a mobile computing device 110 as input, may determine if the device's geographic location corresponds to a transaction geographic location as stored in the transaction message, and may output a result of the determination to another module or engine of the second computing device 106. In some instances, the transaction processing module 314 may store the result in a data element in an authorization request, such as a data element configured to store authorization data, for forwarding to a financial institution for a determination based thereon. In some embodiments, the transaction processing module 314 may be configured to generate authorization responses indicating denial of a payment transaction if a determination that a mobile device geographic location does not correspond to a transaction geographic location.

The second computing device 106 may also include a transmitting device 316. The transmitting device 316 may be configured to transmit data over one or more networks via one or more network protocols. In some embodiments, the transmitting device 316 may be configured to transmit data over the payment rails, such as using specially configured infrastructure associated with payment networks 118 for the transmission of transaction messages that include sensitive financial data and information, such as identified payment credentials. In some instances, the transmitting device 316 may be configured to transmit data to the first computing device 104, payment networks 118, merchant systems 116, financial institutions, and other entities via alternative networks, such as the Internet. In some embodiments, the transmitting device 316 may be comprised of multiple devices, such as different transmitting devices for transmitting data over different networks, such as a first transmitting device for transmitting data over the payment rails and a second transmitting device for transmitting data over the Internet. The transmitting device 316 may electronically transmit data signals that have data superimposed that may be parsed by a receiving computing device. In some instances, the transmitting device 316 may include one or more modules for superimposing, encoding, or otherwise formatting data into data signals suitable for transmission.

The transmitting device 316 may be configured to electronically transmit data signals to the first computing device 106 that are superimposed or otherwise encoded with a location request, which may include at least an account identifier for which a geographic location is requested. The transmitting device 316 may also be configured to electronically transmit data signals to the payment network 118 via the associated payment rails that are superimposed or otherwise encoded with transaction messages.

The second computing device 106 may also include a memory 318. The memory 318 may be configured to store data for use by the second computing device 106 in performing the functions discussed herein. The memory 318 may be configured to store data using suitable data formatting methods and schema and may be any suitable type of memory, such as read-only memory, random access memory, etc. The memory 318 may include, for example, encryption keys and algorithms, communication protocols and standards, data formatting standards and protocols, program code for modules and application programs of the processing device, and other data that may be suitable for use by the second computing device 106 in the performance of the functions disclosed herein as will be apparent to persons having skill in the relevant art. In some embodiments, the memory 318 may be comprised of or may otherwise include a relational database that utilizes structured query language for the storage, identification, modifying, updating, accessing, etc. of structured data sets stored therein.

### Process for Privacy Protection in Geolocation-Based Authorization

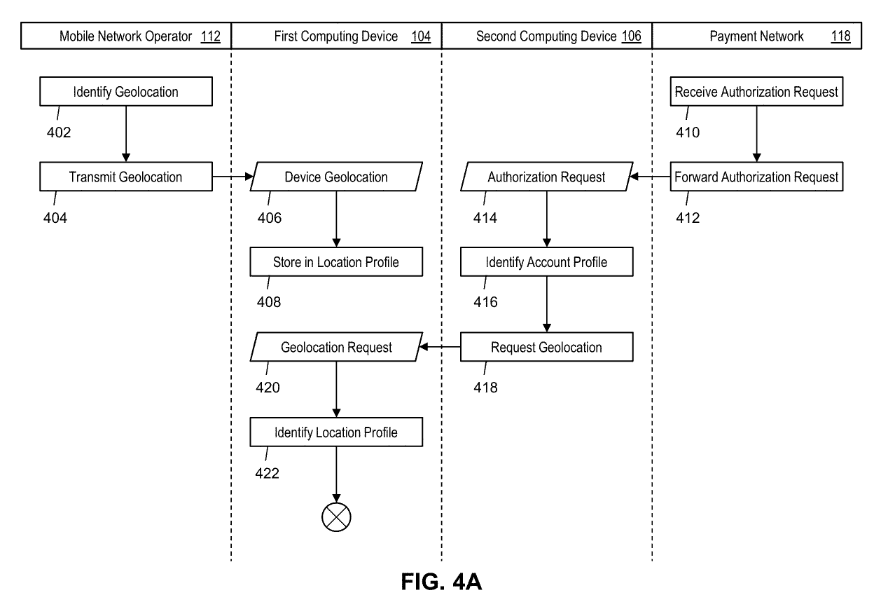

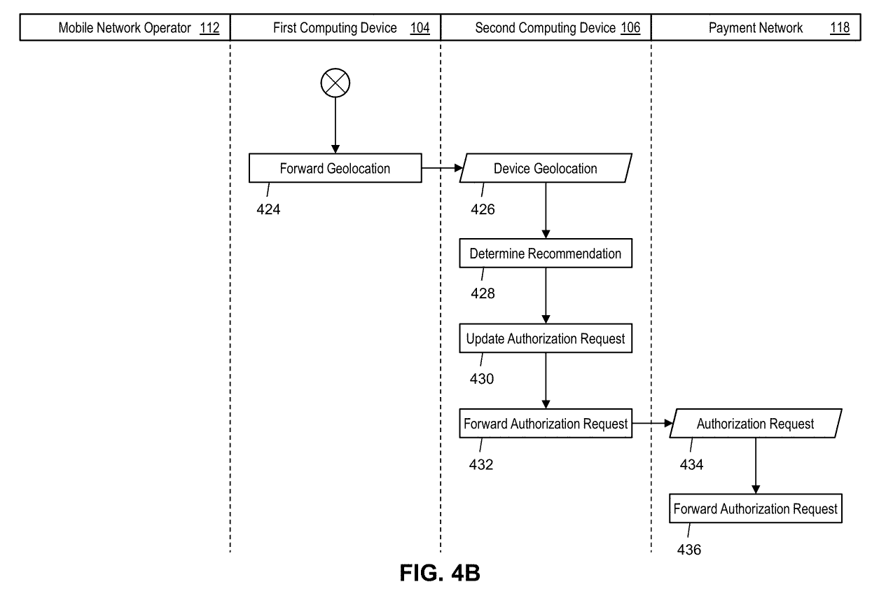

FIGS. 4A and 4B illustrate a process for using mobile device geolocation in an authorization determination for a payment transaction using the system 100 of FIG. 1, where the processing system 200 is configured to protect consumer privacy in usage of the mobile device geolocation.

In step 402, the mobile network operator 112 may identify the geographic location of a mobile computing device 110 registered with the processing system 102 for use of the privacy-protected service. The mobile network operator 112 may identify the geographic location using any suitable method, such as cellular network triangulation, global positioning system, network identification, etc. In step 404, the mobile network operator 112 may electronically transmit the identified geolocation and a device identifier associated with the mobile computing device 110 to the first computing device 104 in the processing system 102.

In step 406, the receiving device 202 of the first computing device 104 may receive the device geolocation and its corresponding device identifier. In step 408, the querying module 210 of the first computing device 104 may execute a query on the location database 208 to store the device geolocation in the corresponding location profile 208. The corresponding location profile 208 may be a location profile 208 that includes the same device identifier as included in the transmission received from the mobile network operator 112.

In step 410, the payment network 118 may receive an authorization request for a payment transaction involving the consumer 108. The authorization request may be a transaction message formatted pursuant to one or more standards, such as the ISO 8583 or 20022 standards, that includes a message type indicator indicative of an authorization request and a plurality of data elements including at least a first data element configured to store a primary account number (e.g., as read from the payment instrument 114), a second data element configured to store a transaction geographic location, a third data element configured to store authorization data, and one or more additional data elements configured to store additional transaction data. In step 412, the payment network 118 may forward the authorization request to the second computing device 106 of the processing system 102 via payment rails associated with the payment network 118.

In step 414, the receiving device 302 of the second computing device 106 may receive the authorization request. In step 416, the querying module 310 of the second computing device 106 may execute a query on the account database 306 included therein to identify an account profile 308 that includes the primary account number stored in the corresponding data element included in the authorization request. In step 418, the transmitting device 316 of the second computing device 106 may electronically transmit a request for geolocation to the first computing device 104 using internal communication networks and methods of the processing system 102, the request including at least the account identifier stored in the identified account profile 308.

In step 420, the receiving device 202 of the first computing device 104 may receive the request for geolocation from the second computing device 106. In step 422, the querying module 210 of the first computing device 104 may execute a query on the location database 206 to identify the location profile 208 that includes the account identifier provided in the geolocation request. The data identification module 214 of the first computing device 104 may identify the device geolocation stored therein, and, in step 424, the transmitting device 216 of the first computing device 104 may electronically transmit the device's geolocation to the second computing device 106 using internal communication networks and methods.

In step 426, the receiving device 302 of the second computing device 106 may receive the geolocation of the mobile computing device 110. In step 428, the transaction processing module 314 of the second computing device 106 may determine a recommendation for approval or denial of the payment transaction with respect to the geolocation, which may be based on a determination if there is a correspondence between the device geolocation and the transaction geographic location stored in the corresponding data element included in the received authorization request. If there is no correspondence, then the recommendation may be to deny the payment transaction. If there is a correspondence, then the recommendation may be to approve.

In step 430, the transaction processing module 314 of the second computing device 106 may store the recommendation in the third data element of the authorization request that is configured to store authorization data. In step 432, the transmitting device 316 of the second computing device 106 may electronically transmit the authorization request back to the payment network 118 via the payment rails associated therewith. In step 434, the payment network 118 may receive the authorization request with the recommendation stored therein, and, in step 436, may forward the authorization request on to an issuing financial institution involved in the payment transaction for authorization thereof.

### Exemplary Method for Privacy Protection in Use of Geolocation for Transaction Authorization

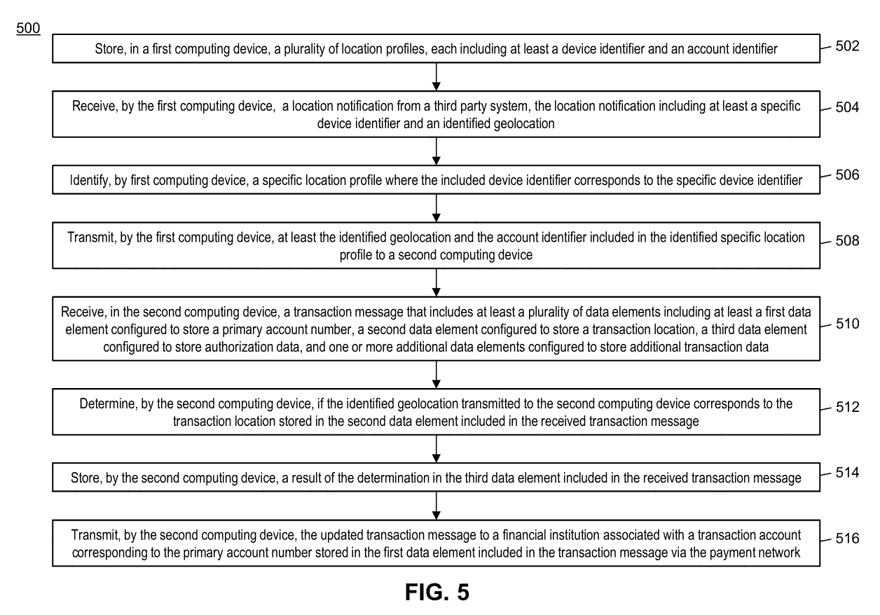

FIG. 5 illustrates a method 500 for the protection of privacy in the use of a mobile device geographic location in determinations related to authorization of an electronic payment transaction.

In step 502, a plurality of location profiles (e.g., location profiles 208) may be stored in a location database (e.g., the location database 206) of a first computing device (e.g., the first computing device 104), wherein each location profile includes a structured data set related to a mobile computing device (e.g., mobile computing device 110) including at least a device identifier and an account identifier. In step 504, a location notification may be received by a receiving device (e.g., the receiving device 202) of the first computing device from a third party system (e.g., the mobile network operator 112), the location notification including at least a specific device identifier and an identified geolocation.

In step 506, a query may be executed by a querying module (e.g., the querying module 210) of the first computing device on the location database to identify a specific location profile where the included device identifier corresponds to the specific device identifier. In step 508, at least the identified geolocation and the account identifier included in the identified specific location profile may be electronically transmitted to a second computing device (e.g., the second computing device 106) by a transmitting device (e.g., the transmitting device 216) of the first computing device.

In step 510, a transaction message may be received by a receiving device (e.g., the receiving device 302) of the second computing device via a payment network (e.g., the payment network 118), wherein the transaction message is related to a payment transaction, is formatted pursuant to one or more standards and includes at least a plurality of data elements including at least a first data element configured to store a primary account number corresponding to the account identifier transmitted to the second computing device, a second data element configured to store a transaction location, a third data element configured to store authorization data, and one or more additional data elements configured to store additional transaction data. In step 512, a transaction processing module (e.g., the transaction processing module 314) of the second computing device may determine if the identified geolocation transmitted to the second computing device corresponds to the transaction location stored in the second data element included in the received transaction message.

In step 514, a result of the determination may be stored by the transaction processing module of the second computing device in the third data element included in the received transaction message. In step 516, the transaction message including the third data element storing the result of the determination may be electronically transmitted by a transmitting device (e.g., the transmitting device 316) of the second computing device to a financial institution associated with a transaction account corresponding to the primary account number stored in the first data element included in the transaction message via the payment network.

In one embodiment, the method 500 may further include generating, by a hashing module (e.g., the hashing module 312) of the second computing device, a hash value via application of one or more hashing algorithms to the primary account number stored in the first data element included in the received transaction message, wherein the generated hash value is equivalent to the account identifier transmitted to the second computing device. In some embodiments, the method 500 may also include: storing, in an account database (e.g., the account database 306) of the second computing device, a plurality of account profiles (e.g., account profiles 308), wherein each account profile includes a structured data set related to a transaction account including at least a primary account number and an associated account identifier; and executing, by a querying module (e.g., the querying module 310) of the second computing device, a query on the account database to identify a specific account profile where the included primary account number corresponds to the primary account number stored in the first data element included in the received transaction message, wherein the account identifier transmitted to the second computing device corresponds to the associated account identifier included in the identified specific account profile.

In one embodiment, the method 500 may further include generating, by a hashing module (e.g., the hashing module 212) of the first computing device, a hash value via application of one or more hashing algorithms to the specific device identifier included in the received location notification, wherein the generated hash value is equivalent to the device identifier included in the identified specific location profile. In some embodiments, the method 500 may also include executing, by the querying module of the first computing device, a second query on the location database to store the identified geolocation included in the received location notification in the identified specific location profile. In one embodiment, the method 500 may further include receiving, by the receiving device of the second computing device, at least the identified geolocation and the account identifier included in the identified specific location profile transmitted by the transmitting device of the first computing device.

In some embodiments, the first computing device may not possess or receive the primary account number stored in the first data element included in the received transaction message. In one embodiment, the second computing device may not possess or receive the specific device identifier included in the received notification location. In some embodiments, each account identifier may be a hash value generated via application of a hashing algorithm to an account number corresponding to a related transaction account. In one embodiment, the transaction message may further include a message type indicator indicative of an authorization request.

### Payment Transaction Processing System and Process

FIG. 6 illustrates a transaction processing system and a process 600 for the processing of payment transactions in the system, which may include the processing of thousands, millions, or even billions of transactions during a given period (e.g., hourly, daily, weekly, etc.). The process 600 and steps included therein may be performed by one or more components of the system 100 discussed above, such as the second computing device 106, consumer 108, payment instrument 114, merchant system 116, payment network 118, etc. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 4A, 4B, and 5, discussed above, with respect to the step or steps involved in the processing of a payment transaction. In addition, the entities discussed herein for performing the process 600 may include one or more computing devices or systems configured to perform the functions discussed below. For instance, the merchant 606 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 606 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the International Organization for Standardization's ISO 8683 standard. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution may generate an authorization request for the payment transaction based on the formatted transaction data. The authorization request may be a specially formatted transaction message that is formatted pursuant to one or more standards, such as the ISO 8683 standard and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution 602 information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 602 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 660, assuming the transaction was approved, the merchant 606 may then provide the products purchased by the consumer 604 as part of the payment transaction to the consumer 604.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 602. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution 602. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644. The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc. that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 illustrates a computer system 700 in which embodiments of the present disclosure, or portions thereof, may be implemented as computer-readable code. For example, the first computing device 104 and second computing device 106 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4A, 4B, 5, and 6.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 4A, 4B, 5, and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for privacy protection in use of geolocation for transaction authorization. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for privacy protection in use of geolocation for transaction authorization, comprising:
storing, in a location database of a first computing device, a plurality of location profiles, wherein each location profile includes a structured data set related to a mobile computing device, the location profile including at least a device identifier and an account identifier;
receiving, by a receiving device of the first computing device, a location notification from a third party system, the location notification including at least a specific device identifier and a geolocation;
executing, by a querying module of the first computing device, a query on the location database to identify a specific location profile where the included device identifier corresponds to the specific device identifier;
electronically transmitting, by a transmitting device of the first computing device, at least the geolocation and the account identifier included in the identified specific location profile to a second computing device;
receiving, by a receiving device of the second computing device, a transaction message related to a payment transaction via a payment network, wherein the transaction message is formatted pursuant to one or more standards and includes at least a plurality of data elements including at least a first data element configured to store a primary account number corresponding to the account identifier transmitted to the second computing device, a second data element configured to store a transaction location, a third data element configured to store authorization data, and one or more additional data elements configured to store additional transaction data;
determining, by a transaction processing module of the second computing device, if the geolocation transmitted to the second computing device corresponds to the transaction location stored in the second data element included in the received transaction message;
storing, by the transaction processing module of the second computing device, a result of the determination in the third data element included in the received transaction message; and
electronically transmitting, by a transmitting device of the second computing device, the transaction message including the third data element storing the result of the determination to a financial institution associated with a transaction account corresponding to the primary account number stored in the first data element included in the transaction message via the payment network.

2. The method of claim 1, further comprising:
generating, by a hashing module of the second computing device, a hash value via application of one or more hashing algorithms to the primary account number stored in the first data element included in the received transaction message, wherein
the generated hash value is equivalent to the account identifier transmitted to the second computing device.

3. The method of claim 1, further comprising:
storing, in an account database of the second computing device, a plurality of account profiles, wherein each account profile includes a structured data set related to a transaction account including at least a primary account number and an associated account identifier; and
executing, by a querying module of the second computing device, a query on the account database to identify a specific account profile where the included primary account number corresponds to the primary account number stored in the first data element included in the received transaction message, wherein
the account identifier transmitted to the second computing device corresponds to the associated account identifier included in the identified specific account profile.

4. The method of claim 1, further comprising:
generating, by a hashing module of the first computing device, a hash value via application of one or more hashing algorithms to the specific device identifier included in the received location notification, wherein
the generated hash value is equivalent to the device identifier included in the identified specific location profile.

5. The method of claim 1, further comprising:
executing, by the querying module of the first computing device, a second query on the location database to store the geolocation included in the received location notification in the identified specific location profile.

6. The method of claim 1, further comprising:
receiving, by the receiving device of the second computing device, at least the geolocation and the account identifier included in the identified specific location profile transmitted by the transmitting device of the first computing device.

7. The method of claim 1, wherein the first computing device does not possess or receive the primary account number stored in the first data element included in the received transaction message.

8. The method of claim 1, wherein the second computing device does not possess or receive the specific device identifier included in the received notification location.

9. The method of claim 1, wherein each account identifier is hash value generated via application of a hashing algorithm to an account number corresponding to a related transaction account.

10. The method of claim 1, wherein the transaction message further includes a message type indicator indicative of an authorization request.

11. A system for privacy protection in use of geolocation for transaction authorization, comprising:
a location database of a first computing device configured to store a plurality of location profiles, wherein each location profile includes a structured data set related to a mobile computing device, the location profile including at least a device identifier and an account identifier;
a receiving device of the first computing device configured to receive a location notification from a third party system, the location notification including at least a specific device identifier and a geolocation;
a querying module of the first computing device configured to execute a query on the location database to identify a specific location profile where the included device identifier corresponds to the specific device identifier;
a transmitting device of the first computing device configured to electronically transmit at least the geolocation and the account identifier included in the identified specific location profile to a second computing device;
a receiving device of the second computing device configured to receive a transaction message related to a payment transaction via a payment network, wherein the transaction message is formatted pursuant to one or more standards and includes at least a plurality of data elements including at least a first data element configured to store a primary account number corresponding to the account identifier transmitted to the second computing device, a second data element configured to store a transaction location, a third data element configured to store authorization data, and one or more additional data elements configured to store additional transaction data;
a transaction processing module of the second computing device configured to
determine if the geolocation transmitted to the second computing device corresponds to the transaction location stored in the second data element included in the received transaction message, and
store a result of the determination in the third data element included in the received transaction message; and
a transmitting device of the second computing device configured to electronically transmit the transaction message including the third data element storing the result of the determination to a financial institution associated with a transaction account corresponding to the primary account number stored in the first data element included in the transaction message via the payment network.

12. The system of claim 11, further comprising:
a hashing module of the second computing device configured to generate a hash value via application of one or more hashing algorithms to the primary account number stored in the first data element included in the received transaction message, wherein
the generated hash value is equivalent to the account identifier transmitted to the second computing device.

13. The system of claim 11, further comprising:
an account database of the second computing device configured to store a plurality of account profiles, wherein each account profile includes a structured data set related to a transaction account including at least a primary account number and an associated account identifier; and
a querying module of the second computing device configured to execute a query on the account database to identify a specific account profile where the included primary account number corresponds to the primary account number stored in the first data element included in the received transaction message, wherein
the account identifier transmitted to the second computing device corresponds to the associated account identifier included in the identified specific account profile.

14. The system of claim 11, further comprising:
a hashing module of the first computing device configured to generate a hash value via application of one or more hashing algorithms to the specific device identifier included in the received location notification, wherein
the generated hash value is equivalent to the device identifier included in the identified specific location profile.

15. The system of claim 11, wherein the querying module of the first computing device is further configured to execute a second query on the location database to store the geolocation included in the received location notification in the identified specific location profile.

16. The system of claim 11, wherein the receiving device of the second computing device is further configured to receive at least the geolocation and the account identifier included in the identified specific location profile transmitted by the transmitting device of the first computing device.

17. The system of claim 11, wherein the first computing device does not possess or receive the primary account number stored in the first data element included in the received transaction message.

18. The system of claim 11, wherein the second computing device does not possess or receive the specific device identifier included in the received notification location.

19. The system of claim 11, wherein each account identifier is hash value generated via application of a hashing algorithm to an account number corresponding to a related transaction account.

20. The system of claim 11, wherein the transaction message further includes a message type indicator indicative of an authorization request.
